(19) United States
(12) Patent Application Publication
(10) Pub. No.: US 2009/0140065 A1
(43) Pub. Date: Jun. 4, 2009

(54) HVAC CONTROLLER WITH SAVE A WIRE TERMINAL

(75) Inventors: Robert D. Juntunen, Minnetonka, MN (US); Reuben W. Meline, Maple Grove, MN (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 11/948,961

(22) Filed: Nov. 30, 2007

(51) Int. Cl. G05D 23/19; G05D 23/12

(52) U.S. Cl. 236/1 C; 236/46 R

(57) ABSTRACT

A HVAC controller for controlling the comfort level of at least a portion of a building is described. In one illustrative embodiment, an HVAC controller for controlling the comfort level of at least a portion of a building by activating and deactivating one or more HVAC components is provided. The HVAC controller may include a special purpose save a wire terminal that provides a multiplexed or otherwise encoded control signal. The HVAC controller may be configured to multiplex, for example, two or more of a call for heat (W) signal, a call for cool (Y) signal, and/or a call for fan (G) signal onto the special purpose save a wire terminal of the HVAC controller. This may free up a wire in a four wire installation to carry, for example, a common (C) signal. A demultiplexer module may be provided adjacent to the one or more HVAC components to demultiplex the multiplexed control signal. This may substantially reduce the cost and complexity of, for example, retrofitting a four wire installation with a 24 VAC powered HVAC controller.

### FIELD

The present invention generally relates to controllers, and more particularly, to heating, ventilation, and air conditioning (HVAC) controllers.

### BACKGROUND

Building control systems often include heating, ventilation, and/or air conditioning (HVAC) systems to control the comfort level within a building. Many building control systems include a HVAC controller that activates and deactivates one or more HVAC components of the HVAC system to affect and control one or more environmental conditions within the building. These environmental conditions can include, but are not limited to, temperature, humidity, and/or ventilation. In many cases, the HVAC controller may include, or have access to, one or more sensors, and may use parameters provided by the one or more sensors to control the one or more HVAC components to achieve one or more programmed or set environmental conditions.

In some installations, an HVAC controller is mounted to a wall or the like of the building or other structure. In some cases, the HVAC controller may be electrically connected to the one or more HVAC components via several wires running through the wall of the building or other structure. For example, in some installations, an HVAC controller may be connected to the one or more HVAC components using four wires including R (24 VAC), W (call for heat), Y (call for cool), and G (call for fan) wires. When so provided, the HVAC controller is often powered by a local power source such as a battery. In other installations, an HVAC controller may be connected to the one or more HVAC components via five wires including R (24 VAC), W (call for heat), Y (call for cool), G (call for fan), and C (Common) wires. In these installations, the HVAC controller is often powered with a 24 VAC or other source through the R (24 VAC) and C (Common) wires. Retrofitting a four wire installation with a five wire configuration can require a contractor or other installer to run a fifth wire through the walls of the building or other structure, which can be difficult, time consuming and expensive.

### SUMMARY

The present invention generally relates to controllers, and more particularly, to heating, ventilation, and air conditioning (HVAC) controllers. In one illustrative embodiment, an HVAC controller for controlling the comfort level of at least a portion of a building by activating and deactivating one or more HVAC components is provided. The HVAC controller may include a save a wire terminal that provides two or more multiplexed or otherwise encoded control signals on a wire. The HVAC controller may be configured to multiplex, for example, two or more of a call for heat (W) signal, a call for cool (Y) signal, and/or a call for fan (G) signal onto the save a wire terminal. This may help free up a wire in a four wire installation to carry, for example, a common (C) signal, which may then be used to power a 24 VAC powered HVAC controller. A demultiplexer module may be provided near the HVAC components to be controlled to demultiplex the multiplexed control signals. This may substantially reduce the cost and complexity of, for example, retrofitting a four wire installation with a 24 VAC powered HVAC controller.

The above summary is provided to facilitate an understanding of some of the innovative features and/or applications of the present invention and is not intended to be a full description. A full appreciation of the invention can be gained by taking the entire specification, claims, drawings, and abstract as a whole.

### BRIEF DESCRIPTION

The invention may be more completely understood in consideration of the following detailed description of various illustrative embodiments of the invention in connection with the accompanying drawings, in which:

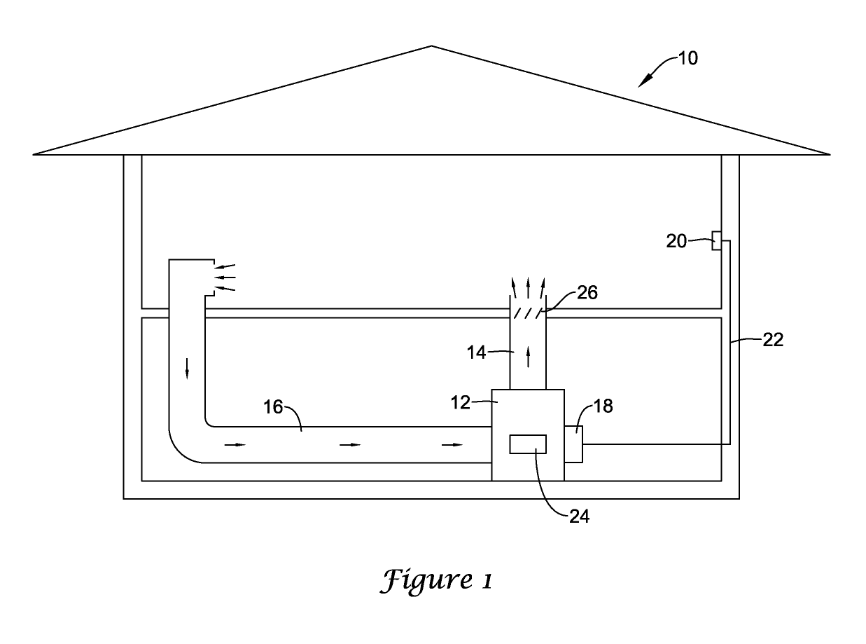

FIG. 1 is a schematic view of a building or other structure with an illustrative heating, ventilation, and air conditioning (HVAC) system;

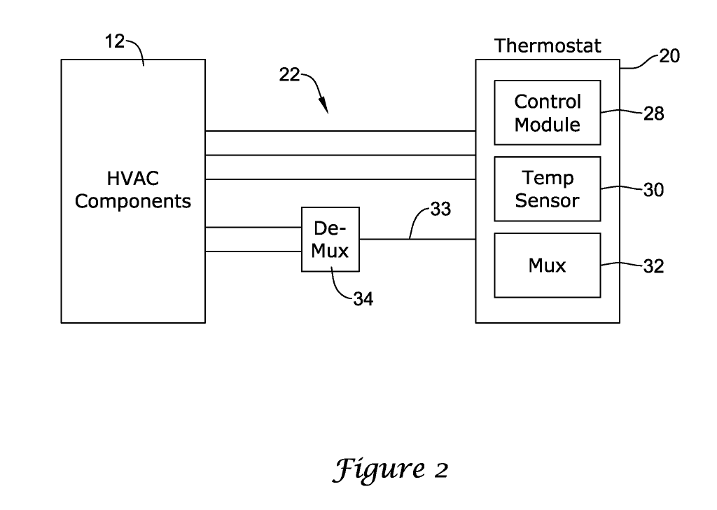

FIG. 2 is schematic diagram showing an illustrative HVAC controller including a multiplexer (MUX) connected to an illustrative demultiplexer (De-MUX) via wire;

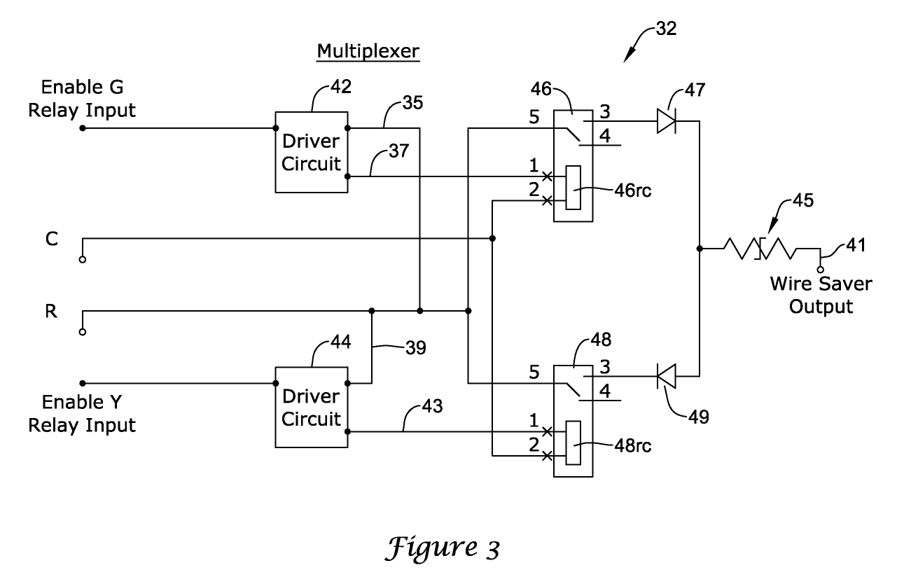

FIG. 3 is a schematic diagram of an illustrative multiplexer circuit that may be used in conjunction with HVAC controller 20 of FIG. 2;

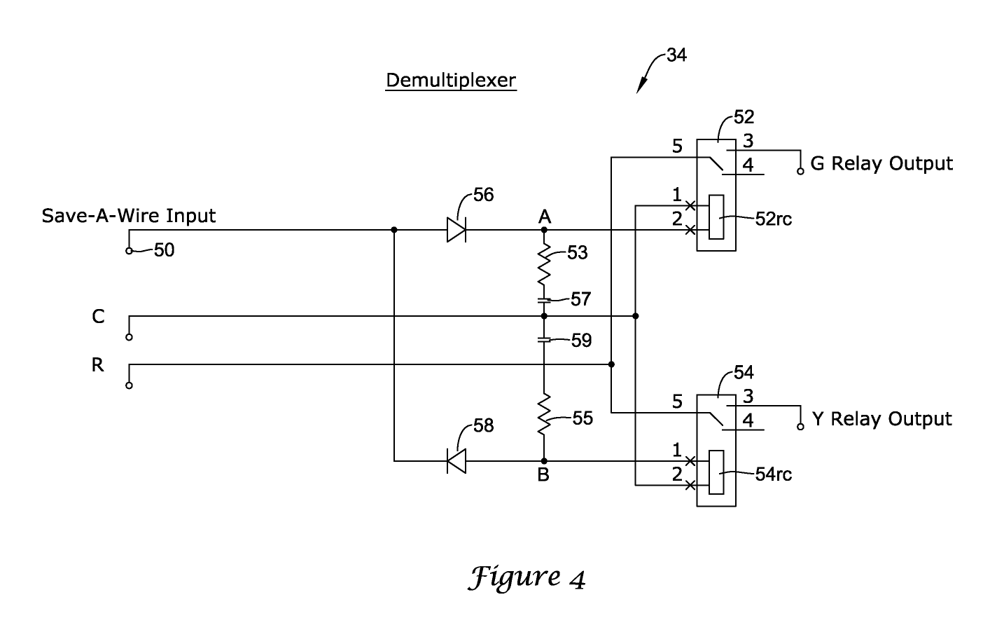

FIG. 4 is a schematic diagram of an illustrative demultiplexer circuit that may be used in conjunction with the multiplexer circuit of FIG. 3;

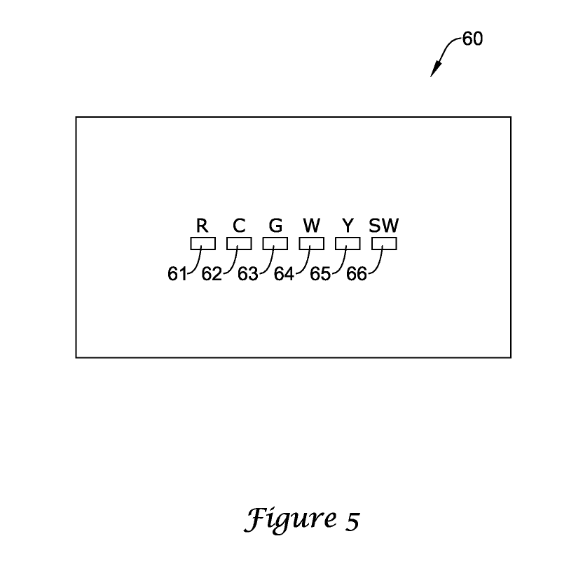

FIG. 5 is a schematic back view of an illustrative a HVAC controller having a save a wire terminal; and

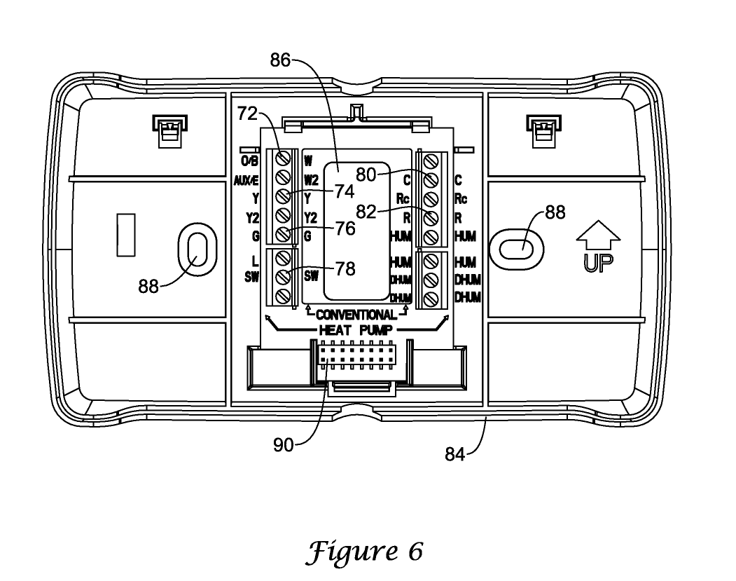

FIG. 6 is a perspective view of an illustrative wall plate for a thermostat.

### DESCRIPTION

The following description should be read with reference to the drawings wherein like reference numerals indicate like elements throughout the several views. The detailed description and drawings show several embodiments which are meant to be illustrative of the claimed invention.

FIG. 1 is a schematic view of a building or other structure with an illustrative heating, ventilation, and air conditioning (HVAC) system. While FIG. 1 shows a typical force air type HVAC system, other types of HVAC systems may be used including hydronic systems, boiler systems, radiant heating systems, or any other suitable type of HVAC system, as desired. The HVAC system of FIG. 1 includes one or more HVAC components 12, a system of vents or ductwork 14 and 16, and an HVAC controller 20. In the illustrative embodiment, the one or more HVAC components 12 may include, but are not limited to, a furnace, a boiler, a heat pump, an air conditioning unit, a humidifier, a dehumidifier, an air exchanger, an air cleaner, and/or the like.

In the illustrative HVAC system of FIG. 1, the one or more HVAC components 12 can provide heated air (and/or cooled air) via the ductwork throughout the building 10 or other structure. As illustrated, the one or more HVAC components 12 may be in fluid communication with every room and/or zone in the building 10 or other structure via the ductwork 14 and 16. In operation, when a heat call signal is provided by the HVAC controller 20, one or more HVAC components 12 (e.g. forced warm air furnace) may be activated to supply heated air to one or more rooms and/or zones within the building 10 or other structure via supply air ducts 14. The heated air may be forced through supply air duct 14 by a blower or fan 24. In this example, the cooler air from each zone may be returned to the one or more HVAC components 12 (e.g. forced warm air furnace) for heating via return air ducts 16. Similarly, when a cool call signal is provided by the HVAC controller 20, the one or more HVAC components 12 (e.g. air conditioning unit) may be activated to supply cooled air to one or more rooms and/or zones within the building 10 or other structure via supply air ducts 14. The cooled air may be forced through supply air duct 14 by the blower or fan 24. In this example, the warmer air from each zone may be returned to the one or more HVAC components 12 (e.g. air conditioning unit) for cooling via return air ducts 16.

In some cases, the system of vents or ductwork 14 and 16 can include one or more dampers 26 to regulate the flow of air. For example, one or more dampers 26 may be coupled to the HVAC controller 20 and can be coordinated with the operation of one or more HVAC components 12. The HVAC controller 20 may be able to actuate damper 26 to an open position, a closed position, and/or a partially open position to modulate the flow of air from the one or more HVAC components 12 to a room and/or zone in the building or other structure 10.

It is contemplated that the HVAC controller 20 may be configured to control the comfort level of the building or structure 10 by activating and deactivating the one or more HVAC components 12. In some cases, the HVAC controller 20 may be a thermostat, such as, for example, a wall mountable thermostat, but this is not required. In one illustrative embodiment, the HVAC controller 20 may be a 24 volt-alternating current (VAC) powered HVAC controller. In this embodiment, the HVAC controller 20 may receive power from a 24 VAC step-down transformer, which may typically be provided near the HVAC components 12 and may be part of the HVAC system for supplying 24 VAC power to some or all of the one or more HVAC components 12. Alternatively, the HVAC controller 20 may be powered locally, such as via a battery.

The HVAC controller 20 may include one or more terminals (shown in FIGS. 6 and 7) that are configured to receive a set of wires 22. The set of wires 22 may be used to electrically connect the HVAC controller 20 to the one or more HVAC components 12. The set of wires 22 may be configured to transmit one or more control signals between the HVAC controller 20 and one or more HVAC components 12. The set of wires 22 may run from HVAC controller 20, through at least a portion of a wall of the building or other structure 10, and connect to one or more HVAC components 12. In some cases, such as for example when the HVAC controller 20 is a 24 VAC powered HVAC controller 20, the illustrative HVAC controller 20 may be configured to operate with three control signals (e.g. call for heat, call for cool, and call for fan), as well as be configured to connect to power and common terminals of a 24 VAC transformer (which is typically located remote from the HVAC controller 20).

In an illustrative embodiment, the HVAC controller 20 may include a special purpose save a wire terminal connected to a multiplexer that is configured to multiplex two (or more) of the control signals onto a single terminal and thus single wire. The multiplexer may reduce the number of wires that are needed to connect the HVAC controller 20 to the one or more HVAC components 12. In some cases, a demultiplexer module 18 may be provided, sometimes near the one or more HVAC components 12, for receiving a multiplexed signal provided by the multiplexer. The demultiplexer module may be configured to demultiplex or otherwise “decode” the multiplexed or otherwise encoded signal provided by the HVAC controller 20. The demultiplexer module may provide demultiplexed or otherwise “decoded” signals to the one or more HVAC components 12.

FIG. 2 is schematic diagram showing an illustrative HVAC controller 20 including a multiplexer (MUX) 32 connected to an illustrative demultiplexer (De-MUX) 34 via wires 22. In the illustrative embodiment, HVAC controller 20 may be a thermostat, such as, for example, a wall mountable thermostat, but this is not required. In FIG. 2, the illustrative HVAC controller 20 includes a control module 28, a temperature sensor 30, and a multiplexer (MUX) 32. Temperature sensor 30 may sense the temperature proximate the HVAC controller 20. As illustrated, temperature sensor 30 may be included with the HVAC controller 20, such as within the housing of HVAC controller 20. However, it is contemplated that, in other cases, HVAC controller 20 may be a control unit that does not include a local temperature sensor, but rather relies on temperature measurements taken by one or more remotely located sensors. In this case, temperature sensor 30 may be located remote from the HVAC controller 20, but in communication therewith.

Control module 28 of HVAC controller 20 may be configured to control the comfort level of at least a portion of the building or other structure 10 by activating and/or deactivating one or more HVAC components 12 (see FIG. 1). In some cases, control module 28 may also be configured to control one or more HVAC functions, such as, for example, HVAC schedules, temperature setpoints, humidity setpoints, trend logs, timers, environment sensing, and/or other HVAC functions, as desired. In the illustrative embodiment, control module 28 may selectively control the comfort level of at least a portion of the building or other structure 10 using the temperature sensed by temperature sensor 30 and/or, if provided, a temperature sensed by a temperature sensor located remote from the HVAC controller 20. In some cases, control module may be configured to provide a heat call signal, a cool call signal, and/or a ventilation or fan call signal, when desired.

The HVAC controller 20 may be operatively connected to one or more HVAC components 12 via wires or cable 22. The HVAC controller 20 may activate and/or deactivate one or more HVAC components 12 via wires or cable 22 to regulate one or more environmental conditions such as temperature, humidity, ventilation, and/or air quality levels within a building or other structure. Example HVAC components may include, but are not limited to, cooling units (e.g. air conditioners), heating units (e.g. boilers, furnaces, etc.), filtration units, dampers, valves, humidifier/dehumidifier units, and/or ventilation units (e.g. fans, blowers, etc.).

In the illustrative embodiment, the HVAC controller 20 includes a multiplexer (MUX) 32. The MUX 32 may be configured to include one or more inputs connected to the control module, and an output connected to one of the wires 22. The MUX 32 may be configured to, for example, multiplex two or more control signals of the control module 28 onto a single multiplexed output signal 33, which may be transmitted over one of wires 22. In some cases, the MUX 32 may multiplex two (or more) of the heat call signal, the cool call signal, and the fan call signal. In some cases, the two or more multiplexed signals may include a second stage heat call signal, a second stage cool call signal, a second stage fan call signal, or any other suitable signal, as desired. When so provided, the multiplexed output signal 33, after being decoded by a demultiplexer module (De-MUX) 34, may be able to control one or more HVAC components 12. For example, the MUX 32 may multiplex a cool call signal and a fan call signal provided by the control module 28 into the multiplexed output signal 33. The demultiplexer module (De-MUX) 34 may demultiplex the multiplexed output signal 33 into a cool call signal and a fan call signal, which can then be provided to the HVAC components 12.

In another example, the MUX 32 may multiplex a heat call signal and a fan call signal onto a multiplexed output signal 33. In yet another example, the MUX 32 may multiplex a heat call signal and a cool call signal onto a multiplexed output signal 33. It is contemplated that, in some cases, the MUX 32 may use the positive phase of a 24 VAC signal to represent one control signal the negative phase for the other control signal, as further described below. However, it is contemplated that digital multiplexing, frequency multiplexing, or any other suitable multiplexing technique may be used, as desired. The demultiplexer module (De-MUX) 34 may be connected to the multiplexed output signal 33. The De-MUX 34 may include an input receiving the multiplexed signal from the MUX 32, and may output two (or more) signals over two wires to the one or more HVAC components 12.

In some buildings or structures, such as, for example, one-heat, one-cool buildings, four wires 22 may be provided between the HVAC controller 20 and the one or more HVAC components 12. In some cases, the four wires 22 may pass through at least a portion of a wall of a building or other structure. In some cases, it may be desirable to power the HVAC controller 20 with a 24 VAC signal. To do so, two of the four wires 22 may be used to connect the terminals of a 24 VAC transformer and the R (24 VAC) and C (Common) terminals of the HVAC controller 20. A third one of the four wires 22 may carry the multiplexed output signal 33, and may extend between the D-MUX 34, which can be located near the HVAC components 12, and the MUX 32 of the HVAC controller 20. The fourth wire may carry a non-multiplexed control signal from the HVAC controller 20 and to one or more of the HVAC components 12.

As shown, the demultiplexed control signals provided by D-MUX 34 may be provided to the one or more HVAC components 12 with two (or more) wires, one for each of the multiplexed control signals. However, since the D-MUX 34 is typically located near the HVAC components 12, the wires from the D-MUX 34 to the one or more HVAC components 12 may not extend through walls and may be relatively easily added or may already be present. As such, in this illustrative embodiment, the installer/contractor may be able to install a 24 VAC-powered HVAC controller 20 in a building or other structure that only has four wires extending between the HVAC controller 20 and the HVAC components 12, without having to run an additional wire through the wall of the building or other structure. This may substantially reduce the cost and complexity of, for example, retrofitting a four wire installation with a 24 VAC powered HVAC controller 20.

While discussed with reference to one terminal of the HVAC controller including multiplexed signal, it is not meant to be limiting in any manner. It is contemplated that the illustrative HVAC controller may include multiple multiplexers, multiple demultiplexers, and/or multiple terminals providing multiplexed signals, as desired. In one case, HVAC controller 20 may include a second multiplexer (not shown) that may be configured to multiplex two or more HVAC control signals onto another terminal of the HVAC controller, so that the HVAC controller includes two multiplexed output signals on two terminals. In another case, it is contemplated that the MUX 32 may include a second output with two or more control signals multiplexed onto the second output.

It should be recognized that HVAC controller 20 of FIG. 2 is merely illustrative and is not meant to be limiting in any manner. It is to be understood that the HVAC controller 20 may be any suitable controller, as desired. In some cases, it is contemplated that the HVAC controller 20 may include a user interface that may allow a user or technician to program and/or modify one or more control parameters of HVAC controller 20, such as programming and/or schedule parameters, as desired. The user interface may include a touch screen, a liquid crystal display (LCD) panel and keypad, a dot matrix display, a computer, one or more buttons, a communications port, and/or any other suitable interface, as desired. In some cases, the user interface of the HVAC controller 20 may be used to select which, if any, of the various control signals provided by control module 28 will be multiplexed by MUX 32.

FIG. 3 is a schematic diagram of an illustrative multiplexer circuit 32 that may be used in conjunction with HVAC controller 20 of FIG. 2. The illustrative multiplexer circuit (MUX) 32 multiplexes a G (fan call) signal and a Y (cool call) signal into a multiplexed output signal 33 and onto a save a wire terminal 41 of the HVAC controller 20. This is merely illustrative, however, and it is contemplated that any two (or more) of, for example, the G (fan call), the Y (cool call), W (heat call), and/or any other suitable signal(s) may be multiplexed into the multiplexed output signal 33 and onto the save a wire terminal 41 of the HVAC controller 20, as desired.

In FIG. 3, the illustrative multiplexer 32 includes two driver circuits 42 and 44, two relays 46 and 48, and two diodes 47 and 49. Driver circuit 42 has an input connected to an Enable G Relay Input signal, which may be provided by control module 28 of the HVAC controller 20. Driver circuit 42 may also have a terminal 35 connected to the R (24 VAC) terminal of the HVAC controller 20, and another terminal 37 connected to the C (Common) terminal of the HVAC controller 20 through the relay coil 46rc of relay 46. Alternatively, in some cases, drivers circuit 42 may be coupled to a rectifying DC supply (not shown), which may be derived from the R terminal and C terminal of the HVAC controller 20, via terminal 35. When the HVAC controller 20 asserts the Enable G Relay Input signal, the driver circuit 42 connects terminals 35 and 37 to produce a current through the relay coil 46rc of relay 46, which closes normally open relay 46.

Likewise, driver circuit 44 has an input connected to an Enable Y Relay Input signal, which may be provided by control module 28 of the HVAC controller 20. Driver circuit 44 may also have a terminal 39 connected to the R (24 VAC) terminal of the HVAC controller 20, and another terminal 43 connected to the C (Common) terminal of the HVAC controller 20 through the relay coil 48rc of relay 48. Alternatively, in some cases, drivers circuit 44 may be coupled to a rectifying DC supply (not shown), which may be derived from the R terminal and C terminal of the HVAC controller 20, via terminal 39. When the HVAC controller 20 asserts the Enable Y Relay Input signal, the driver circuit 44 connects terminals 39 and 43 to produce a current through the relay coil 48rc of relay 48, which then closes normally open relay 48. As illustrated, the pin labeled 3 of relay 46 is connected to the anode of diode 47, with the cathode of diode 47 connected to the save a wire terminal 41 through a current limiting resistor 45. Likewise, the pin labeled 3 of relay 48 is connected to the cathode of diode 49 with the anode of diode 49 connected to the save a wire terminal 41 through current limiting resistor 45.

During operation, the control module 28 of the HVAC controller 20 may activate and/or enable driver circuit 42 and/or 44 via the Enable G Relay Input and/or the Enable Y Relay Input signals. When driver circuit 42 is activated and/or enabled by the Enable G Relay Input, the relay 46 closes (i.e. connecting pin 5 to pin 3) and connects the R (24 VAC) terminal of the HVAC controller 20 to the anode of diode 47. The diode 47 only allows current to flow in one direction, that is, from the relay 46 out through the diode 47 and to the save a wire terminal 41, but not in the opposite direction. Likewise, when driver circuit 44 is activated and/or enabled by the Enable Y Relay Input signal, the relay 48 closes (i.e. connecting pin 5 to pin 3) and connects the R (24 VAC) terminal of the HVAC controller 20 to the cathode of diode 49. The diode 49 only allows current to flow in one direction, that is, from the save a wire terminal 41, through the diode 49, and into the relay 48, but not in the opposite direction. In this illustrative embodiment, the save a wire terminal 41 may be include the positive half of the R (24 VAC) power signal when the Enable G Relay Input signal is activated, the negative half of the R (24 VAC) power signal when the Enable Y Relay Input signal is activated, and both the positive half and the negative half of the R (24 VAC) power signal when the Enable G Relay Input signal and the Enable Y Relay Input signal are both activated by the HVAC controller 20.

The output of the multiplexer circuit 32 is provided on the save a wire terminal 41 of FIG. 3, which may be connected to the input of a demultiplexer circuit (e.g. D-MUX 34), an example of which is shown in FIG. 4, using a single wire. It should be recognized that the foregoing multiplexer circuit 32 is merely illustrative and is not meant to be limiting in any manner. It is contemplated that any suitable multiplexer or other encoder type circuit or method may be used to multiplex or otherwise encode two or more control signals onto a single wire, as desired.

FIG. 4 is a schematic diagram of an illustrative demultiplexer circuit (D-MUX) 34 that may be used in conjunction with the multiplexer circuit (MUX) 32 of FIG. 3. In the illustrative embodiment, the demultiplexer circuit (D-MUX) 34 may include two relays 52 and 54, two diodes 56 and 58, two resistors 53 and 55, and two capacitors 57 and 59. During operation, when the G relay is to be activated at the HVAC components (i.e. when the Enable G Relay Input signal of FIG. 3 is activated), the positive half of the R (24 VAC) power signal is provided to the input terminal 50 of the demultiplexer circuit 34. This produces a current flow through diode 56, which has its anode connected to the input terminal 50 and its cathode connected to Node A. A low pass filter, formed using resistor 53 and capacitor 57, extends from Node A to the C (Common) terminal as shown. The low pass filter provides a positive DC voltage relative to Common at Node A as long as the positive half of the R (24 VAC) power signal is provided to the input terminal 50 of the demultiplexer circuit 34. The voltage at Node A produces a current through the resistor 53, the relay coil 52rc of the normally open relay 52, and to Common. This current in the relay coil 52rc is sufficient to close the relay 52. When relay 52 is closed, the R (24 VAC) power signal is passed from pin 5 of relay 52 to the G Relay Output terminal of the demultiplexer circuit 34. This signal may be provided to the fan call terminal of the HVAC components 12 to enable the fan or blower.

Likewise, when the Y relay 54 is to be activated (i.e. when the Enable Y Relay Input signal of FIG. 3 is activated), the negative half of the R (24 VAC) power signal is provided to the input terminal 50 of the demultiplexer circuit 34. This produces a current flow through diode 58, which has its cathode connected to the input terminal 50 and its anode connected to Node B. A low pass filter, formed from resistor 55 and capacitor 59, extends from Node B to the C (Common) terminal as shown. The low pass filter provides a negative DC voltage at Node B as long as the negative half of the R (24 VAC) power signal is provided to the input terminal 50 of the demultiplexer circuit 34. The voltage at Node B produces a current through the resistor 55, the relay coil 54rc of the normally open relay 54, and to Common. This current in the relay coil 54rc is sufficient to close the relay 54. When relay 54 is closed, the R (24 VAC) power signal is passed from pin 5 of relay 54 to the Y Relay Output terminal of the demultiplexer circuit 34. This signal may then be provided to the cool call terminal of the HVAC components 12 to enable the cooling equipment.

It should be recognized that the foregoing demultiplexer circuit (D-MUX) 34 is merely illustrative and is not meant to be limiting in any manner. It is contemplated that any suitable demultiplexer or other decoder type circuit may be used to demultiplex or otherwise decode two or more control signals from a single wire, as desired. Also, while the foregoing has been described with reference to the G and Y terminals being multiplexed/demultiplexed, it is contemplated that any two or more of the G, Y, W or any other suitable terminals may be multiplexed/demultiplexed, as desired.

FIG. 5 is a schematic back view of an illustrative a HVAC controller having a save a wire terminal. In the illustrative diagram, the HVAC controller generally shown at 60, which may, in some cases, be a wall mountable thermostat, may include an R terminal 61, a C terminal 62, a G terminal 63, a W terminal 64, a Y terminal 65, and SW (Save a Wire) terminal 66.

In the case of a 5-wire installation, the installer may connect the R-terminal 61 to a wire and the C terminal 62 to a second wire. These wires may be connected to the windings of a HVAC transformer, and may provide in some cases 24 volts-alternating current to power the HVAC controller 60. The installer can attach the remaining 3 wires to the G terminal 63, W terminal 64, and Y terminal 65. In this installation, the save-a-wire terminal 66 may be left unconnected. However, the installer may connect one of the G, W, or Y wires to the save-a-wire terminal 66 to provide a multiplexed signal, if desired.

In the case of a 4-wire installation, the installer may connect the R-terminal 61 to a first wire and the C terminal 62 to a second wire. These wires may be connected to the windings of a HVAC transformer to provide in some cases 24 volts-alternating current to power the HVAC controller 60. The installer may then connect the save-a-wire terminal 66 to a third wire. In this case, the installer may also install a demultiplexer module, such as demultiplexer module 34 of FIG. 2, at the opposite end of the third wire. The installer may also connect a fourth wire to one of the non-multiplexed signal terminal (e.g. one of the G terminal 63, W terminal 64, or Y terminal. 65 that are not multiplexed by the HVAC controller 60 onto the save-a-wire terminal 66). In one example, the HVAC controller 60 may multiplex the G signal and the Y signal onto the save-a-wire terminal 66, and then the fourth wire may be connected to the W terminal 64. It should be recognized that this is only illustrative and that any suitable combination of signals may be multiplexed, as desired.

While FIG. 5 shows six terminals on the HVAC controller 60, it is contemplated that the two (or more) multiplexed signals may not be provided with a terminal on the back of the HVAC controller 60. For example, when the G signal and Y signal are multiplexed, the G terminal 63 and the Y terminal 65 may be removed from the HVAC controller 60 entirely, if desired. In some cases, terminals 61, 62, 63, 64, 65, and 66 of the HVAC controller 60 may be screw terminals, quick-release terminals, snap-connector terminals, solder pad terminal, or any other suitable type of terminal or combination of terminals, as desired.

FIG. 6 is a perspective view of an illustrative wall plate 84 for a thermostat (not shown). The illustrative wall plate 84 includes a save-a-wire terminal 78. In the illustrative embodiment, the wall plate 84 may be secured to a wall of a building or other structure using mounting holes 88. In some cases, the wall plate 84 may be positioned so that the wires for electrically connecting the thermostat to the one or more HVAC components may pass from the wall and through opening 86 in the wall plate 84. As shown, wall plate 84 may include a number of terminals to connect the wires, such as, a W terminal 72, a Y terminal 74, a G terminal 76, a SW terminal 78, a C terminal 80, and an R terminal 82, as well as a number of other terminals. As illustrated, the terminals are screw type terminals, however, it is contemplated that any suitable number and type of terminals may be used, as desired. Additionally, as illustrated, the number of terminals may use different letters or identifiers depending on the HVAC components to be connected, such as, for example, a conventional forced air furnace system, a heat pump system, a boiler system, etc. Wall plate 84 may include one or more pin connectors 90 to electrically connect the number of terminals of the wall plate 84 to the thermostat itself, which may be configured to snap onto the illustrative wall plate 84.

Having thus described the preferred embodiments of the present invention, those of skill in the art will readily appreciate that yet other embodiments may be made and used within the scope of the claims hereto attached. Numerous advantages of the invention covered by this document have been set forth in the foregoing description. It will be understood, however, that this disclosure is, in many respect, only illustrative. Changes may be made in details, particularly in matters of shape, size, and arrangement of parts without exceeding the scope of the invention. The invention's scope is, of course, defined in the language in which the appended claims are expressed.

1. A HVAC controller comprising:
a control module for controlling the comfort level of at least a portion of the building by providing two or more control signals for activating and deactivating one or more HVAC components of the HVAC system;
two or more terminals coupled to the control module, the two or more terminals configured to receive two or more wires electrically connected to the one or more HVAC components; and
a multiplexer having one or more inputs connected to the control module and an output connected to a first one of the two or more terminals, wherein the multiplexer is configured to multiplex two or more control signals of the control module onto the first one of the two or more terminals.

2. The HVAC controller of claim 1 wherein a second one of the two or more terminal of the HVAC controller is connected to a first winding of a transformer and a third one of the two or more terminals of the HVAC controller is connected to a second winding of the transformer.

3. The HVAC controller of claim 2 wherein the two or more control signals of the control module includes a fan control signal, a cooling control signal, and a heating control signal.

4. The HVAC controller of claim 3 wherein the multiplexer multiplexes two of the fan control signal, cooling control signal, and heating control signal onto the first one of the two or more terminals.

5. The HVAC controller of claim 4 wherein the multiplexer multiplexes the fan control signal and the cooling control signal onto the first one of the two or more terminals.

6. The HVAC controller of claim 4 wherein a fourth one of the two or more terminals of the HVAC controller is connected to the control module for receiving a control signal for the one of the fan control signal, the cooling control signal, and the heating control signal that is not multiplexed by the multiplexer.

7. The HVAC controller of claim 1 wherein the multiplexer includes a first input for receiving a call for cool signal and a second input for receiving a call for fan signal.

8. The HVAC controller of claim 7 wherein the multiplexer includes a first driver circuit coupled to the first input and a second driver circuit coupled to the second input.

9. The HVAC controller of claim 8 wherein the multiplexer includes a relay coupled to each of the first driver circuit and the second driver circuit.

10. The HVAC controller of claim 7 wherein the multiplexer includes a third input coupled to a first side of a winding of a transformer and a fourth input coupled to a second side of the winding of the transformer.

11. The HVAC controller of claim 1 wherein the HVAC controller is a wall mountable thermostat.

12. The HVAC controller of claim 1 wherein the multiplexer is configured to multiplex two or more control signals of the control module onto a second one of the two or more terminals.

13. A thermostat comprising:
a control module for controlling the comfort level of at least a portion of the building by activating and deactivating one or more HVAC components of the HVAC system;
a first terminal coupled to the control module, the first terminal configured to provide a heating control signal;
a second terminal coupled to the control module, the second terminal configured to provide a cooling control signal;
a third terminal coupled to the control module, the third terminal configured to provide a fan control signal; and
a fourth terminal coupled to the control module, the fourth terminal configured to provide a multiplexed control signal for two or more of the heating control signal, the cooling control signal, and the fan control signal.

14. The thermostat of claim 13 further comprising:
a fifth terminal coupled to the control module, the fifth terminal configured to be connected to a first side of a winding of an HVAC system transformer; and
a sixth terminal coupled to the control module, the sixth terminal configured to be connected to a second side of the winding of the HVAC system transformer.

15. A building control system comprising:
one or more HVAC components;
a wall mountable thermostat configured to control the comfort level of at least a portion of the building control system by providing two or more control signals for activating and deactivating the one or more HVAC components, wherein two of the two or more control signals are multiplexed onto a single multiplexed output signal; and
a demultiplexer module configured to be connected to the multiplexed output signal of the thermostat and connected to at least one of the one or more HVAC components.

16. The building control system of claim 15 wherein the thermostat multiplexes two of a fan control signal, a cooling control signal, and a heating control signal onto the single multiplexed output signal.

17. The building control system of claim 15 wherein the thermostat includes one or more terminals configured to receive one or more wires electrically connected to the one or more HVAC components and/or the demultiplexer module.

18. The building control system of claim 17 wherein a first one of the one or more terminals is connected to the multiplexed output signal, a second one of the one or more terminals is connected to a first side of a winding of an HVAC transformer, and a third one of the one or more terminals is connected to a second side of the winding of the HVAC transformer.

19. The building control system of claim 18 wherein a fourth one of the one or more terminals provides a non-multiplexed one of the fan control signal, the cooling control signal, and the heating control signal.

20. The building control system of claim 15 wherein the thermostat is a 24 volt-alternating current powered thermostat.

21. The building control system of claim 20 wherein the thermostat is powered by and provides the two or more control signals for activating and deactivating the one or more HVAC components via four or less wires.
